(19) United States
(12) Patent Application Publication
(10) Pub. No.: US 2020/0049201 A1
(43) Pub. Date: Feb. 13, 2020

(54) MACHINE WITH A SYSTEM FOR AXIAL BLOCKING OF THE SHAFT

(71) Applicant: MOTEURS LEROY-SOMER, Angouleme Cedex 9 (FR)

(72) Inventors: Pascal Gauthier, Asnieres-Sur-Nouere (FR); Pascal Beynaud, Saint-Saturnin (FR)

(21) Appl. No.: 16/344,564

(22) PCT Filed: Oct. 25, 2017
(86) PCT No.: PCT/EP2017/077278

§ 371 Date: Apr. 24, 2019

(30) Foreign Application Priority Data
Oct. 25, 2016 (FR) 1660317

(51) Int. Cl. F16C 35/073; H02K 5/173; F16C 33/66

(52) U.S. Cl. CPC F16C 35/073; F16C 33/6607; H02K 5/1732

(57) ABSTRACT

A machine including at least one bearing mount; at least one bearing carried by the bearing mount, the bearing comprising inner and outer races and rolling elements between the races; a shaft engaged in the bearing, axially blocked relative to the inner race; a pushrod cover arranged on one side of the bearing, having a surface opposite the bearing and having, on its radially outer edge, a bead of material in contact with the outer race; at least one push element movable transversely to the axis of rotation (X) of the shaft in order to exert a pressure on said surface of the push rod cover in order to press it against the outer race and axially block said outer race.

The present invention relates to rotary machines including a shaft engaged in at least one bearing carried by a bearing mount, and more particularly but not exclusively electric rotary machines such as motors or alternators.

It may be necessary to block a bearing axially in the corresponding bearing mount.

JP S59 53053 discloses a device for adjusting the axial position of a rotary shaft after assembly in an electric motor.

U.S. Pat. No. 5,001,377 describes a lubrication system for antifriction bearings supporting a rotary shaft in an electric motor.

DE 198 24 382 A1 discloses a gear unit with worm screw including at least one worm shaft movable in the axial direction.

U.S. Pat. No. 3,147,050 describes bearing mount assembly means for a rotary machine for holding a bearing mount in its housing.

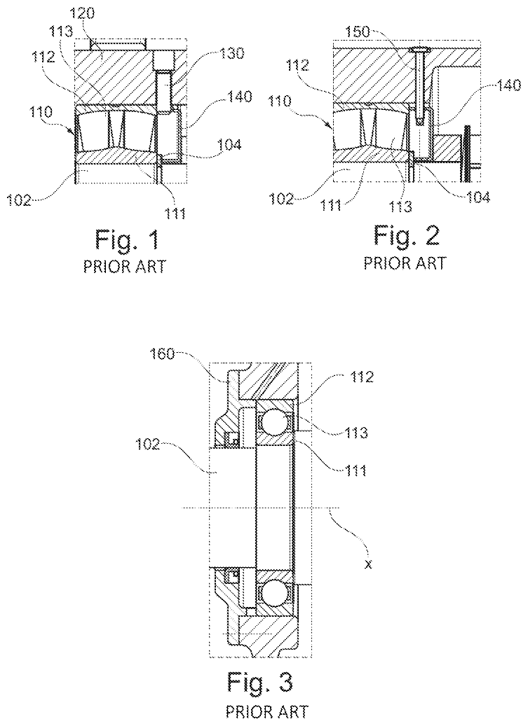

A first way of proceeding consists, as illustrated at FIGS. 1 and 2, of axially blocking the bearing 110 by means of a circlip 104 at the inner race 111 and of inserting a spring pin 130 in a drilled hole of the bearing mount 120 so as to block axially the outer race 112. A specific piece 140 held by screws 150 is added to protect the bearing 110 against the penetration of external particles and/or to prevent the grease from coming out and polluting the surrounding areas.

Such a solution can prove difficult to implement in a small space. In addition, it is difficult to control the push exerted by the spring pin on the outer race 112 and the axial blocking force of the pin.

Another way of doing, illustrated on FIG. 3, consists of fastening a piece 160 called “capping” on the bearing mount 120 by means of screws with centers parallel to the axis of rotation of the shaft.

In this case, controlling the axial pressure of the capping 160 on the bearing, combined with protecting the bearing, is an operation that can prove delicate, perhaps costly.

A need consequently exists to benefit from a solution making it possible reliably to ensure axial blocking, with the force required, of a bearing, and protecting same, even in a small space.

The invention achieves this objective thanks to a rotary machine including:

at least one bearing mount,

at least one bearing carried by the bearing mount, the bearing including inner and outer races and rolling elements between the races,

a shaft engaged in the bearing, axially blocked relative to the inner race,

a pushrod cover arranged on one side of the bearing, having a surface opposite the bearing,

at least one push element movable transversally to the axis of rotation of the shaft in order to exert a pressure on said surface of the pushrod cover in order to press it against the outer race and axially block said outer race.

Thanks to the invention, the push element acts by corner effect on the pushrod cover and the push exerted by the pushrod cover on the bearing can be more easily controlled, while protecting the bearing.

The push element or each push element is preferably a screw. The push exerted by the pushrod cover on the bearing can therefore easily be controlled by screwing the screw more or less, and by controlling the tightening torque of the screw for example.

The push element or each push element is preferably oriented perpendicularly to the axis of rotation of the shaft. This facilitates access to the push element and can make it possible easily to obtain the desired corner effect. This can also make it possible to realize a compact machine in terms of the means implemented in order to ensure axial blocking of the shaft.

It can be advantageous for said surface to extend obliquely relative to the axis of rotation of the shaft, preferably being tapered, flaring towards the bearing.

In this case, the push element preferably has a slope at its end that is substantially equal to that of said surface in the zone of contact of the push element on said surface, the push element then preferably consisting of a screw with a tapered tip.

The pushrod cover can have, on its radially outer edge, a bead of material in contact with the outer race. The side of this bead in contact with the outer race preferably has a shape that matches that of the side facing the outer race.

The push elements are preferably at least two in number, so as to distribute the clamping force over the periphery of the outer race. The push elements are preferably, in this case, diametrically opposite. More preferably, the push elements are at least three in number, being uniformly distributed on the periphery of the outer race.

The pushrod cover can have, on its radially inner edge, a turnback directed towards the radially inner race. The pushrod cover extends preferably with a small clearance away from the shaft, so as to retain the grease and effectively protect the bearing. This clearance is for example less than or equal to 1 mm. If need be, there can be an additional friction seal, of the lip seal type or equivalent.

The outer race can be axially immobilized by any means on the side opposite the pushrod cover, and for example the outer race is axially in contact with a projection of the bearing mount on the side opposite the pushrod cover.

The machine can include a second cover, on the side opposite the pushrod cover, in order to ensure its protection and to retain the grease.

The pushrod cover can be made in any suitable material, in particular in plastic, composite or metal, in particular aluminum, material. The pushrod cover is preferably designed not to be deformed when it is pressed against the outer race.

The machine according to the invention can consist of a motor, an alternator or a reduction gear.

Another object of the invention is a method for axially immobilizing the shaft of a machine according to the invention, such as that described above, including the step consisting of moving the push element or elements relative to the bearing mount so as to cause the pushrod cover to press the outer race of the bearing and to immobilize this race axially relative to the bearing mount.

The push element or each push element is preferably screwed into the bearing mount so as to press the pushrod cover against the outer race. The tightening torque of the screw is preferably controlled. This makes it possible easily to control the axial blocking force exerted by the pushrod cover on the outer race of the bearing.

Other characteristics and advantages of the present invention will emerge on reading the detailed description that will follow, of a non-limitative embodiment example of said invention, and on examining the attached drawing, on which:

FIGS. 1 and 2, previously described, are schematic and partial axial sections of a machine according to the prior art,

FIG. 3 is a view similar to FIGS. 1 and 2 of an embodiment variant according to the prior art, and

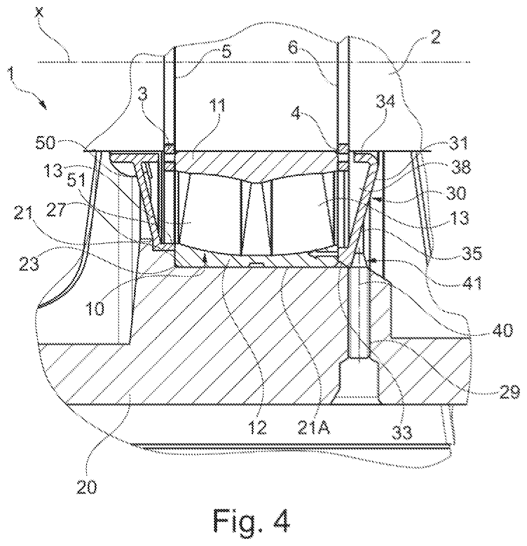

FIG. 4 shows, in axial section, in a schematic and partial manner, an example of a machine realized in accordance with the invention.

The machine 1 according to the invention, partially shown at FIG. 4, includes a shaft 2 turning around an axis of rotation X.

The machine 1 is for example an electric motor.

The shaft 2 is engaged in a bearing 10 including an inner race 11, an outer race 12 and rolling elements 13 arranged between the races 11 and 12.

In the example considered, the rolling elements 13 are rollers but the invention is not limited to a particular type of bearing, and the rolling elements can be balls.

The inner race 11 is axially immobilized on the shaft 2 by circlips 3 and 4 installed in corresponding grooves 5 and 6 of the shaft 2. In variants, the immobilization is done differently, thanks for example to a projection on the shaft.

The outer race 12 is carried by a bearing mount of the machine, having an opening with the shaft passing through it.

The bearing mount 20 has a housing 21 in which the outer race 12 of the bearing 10 is accommodated. The housing 21 has a projection 23 against which the outer race 12 presses axially.

A pushrod cover 30 is arranged on the side opposite the projection 23 so as to press the outer race 12 against the projection 23.

This pushrod cover 30 has a wall 31, tapered, converging away from the projection 23, extending substantially over the entire radial dimension of the space between the bottom 21a of the housing 21 and the shaft 2.

The pushrod cover 30 has, on its radially outer edge, towards the projection 23, a bead of material 33 and on its radially inner edge a turnback 34 turned towards the bearing 10, extending substantially parallel t the axis X.

The bead 33 presses axially against the outer race 12 on the side opposite the projection 23.

Several push elements, consisting of the screws 40, only one of which is apparent on FIG. 1, are arranged on the bearing mount 20 so as to exert a pressure on the pushrod cover 30 in order to press it against the bearing 10.

The screws 40 are screwed into corresponding tapped holes 29 of the bearing mount 20, distributed uniformly, oriented perpendicularly to the axis X, and each having a tapered tip 41 of the same taper as the surface 35 of the wall 31 opposite the bearing 10.

The tapered tip 41 presses against the wall 31 on the side opposite the bead 33. By screwing the screw 40, an axial push is transmitted by corner effect to the outer race 12.

By screwing the screw 40 more or less and by controlling the tightening torque, it is thus possible precisely to control the axial push exerted by the pushrod cover 30 on the outer race 12.

The turnback 34 extends with a small clearance from the shaft 2 so as to retain the grease present in the space 38 between the bearing 10 and the pushrod cover 30.

On the side opposite the pushrod cover 30, the machine can include a cover 50 extending between the bearing mount 20 and the shaft 2, with a small clearance with it, as illustrated.

The cover 50 can include a turnback 51 towards the bearing, on its radially outer edge, said turnback being axially immobilized between the outer race 12 and a projection 27 of the bearing mount 20.

Of course, the invention is not limited to the illustrated example. For example, the machine is a reduction gear or an alternator, or any other mechanism where there is value in axially blocking a shaft guided by at least one bearing.

In variants, the cover 50 is absent; also in variants, the machine is realized without the projection 23.

1. A rotary machine, including:
at least one bearing mount;
at least one bearing carried by the bearing mount, the bearing including inner and outer races and rolling elements between the races;
a shaft engaged in the bearing, axially blocked relative to the inner race;
a pushrod cover arranged on one side of the bearing, having a surface opposite the bearing, and having on its radially outer edge a bead of material in contact with the outer race;
at least one push element moved transversally to the axis of rotation of the shaft in order to exert a pressure on said surface of the pushrod cover in order to press it against the outer race and axially block same.

2. The machine as claimed in claim 1, the push element or each push element being a screw.

3. The machine as claimed in claim 1, the push element or each push element being oriented perpendicularly to the axis of rotation of the shaft.

4. The machine as claimed in claim 1, said surface extending obliquely relative to the axis of rotation of the shaft.

5. The machine as claimed in claim 1, said surface being tapered, flaring towards the bearing.

6. The machine as claimed in claim 4, the push element having a slope at its end, substantially equal to that of said surface in the zone of contact of the push element on said surface.

7. The machine as claimed in claim 1, the pushrod cover having, on its radially inner edge, a turnback directed towards the radially inner race.

8. The machine as claimed in claim 1, the outer race being axially in contact with a projection of the bearing mount on the side opposite the pushrod cover.

9. The machine as claimed in claim 1, including a second cover, on the side opposite the pushrod cover.

10. The machine as claimed in claim 1, the pushrod cover being made in plastic, composite or metal material.

11. The machine as claimed in claim 1, consisting of a motor, an alternator or a reduction gear.

12. The machine as claimed in claim 2, the push element or each push element being screwed into the bearing mount so as to press the pushrod cover against the outer race.

13. A method for axially immobilizing the shaft of a machine such as that defined in claim 1, including the step consisting of moving the push element or each push element transversally to the axis of rotation of the shaft so as to cause the pushrod cover to press the outer race of the bearing and to immobilize this race axially relative to the bearing mount.

14. The method as claimed in claim 13, the push element or each push element being screwed into the bearing mount so as to press the pushrod cover against the outer race.

15. The method as claimed in claim 14, the push element or each push element being screwed with a controlled tightening torque.

16. The machine as claimed in claim 6, the push element consisting of a screw with a tapered tip.

17. The machine as claimed in claim 16, the screw with a tapered tip having the same taper as the surface.
